(19) United States
(12) Patent Application Publication
(10) Pub. No.: US 2021/0277637 A1
(43) Pub. Date: Sep. 9, 2021

(54) WATER OUTLET DEVICE

(71) Applicant: Xiamen Solex High-Tech Industries Co., Ltd., Xiamen (CN)

(72) Inventors: Shilong WU, Xiamen (CN); Donghai CHEN, Xiamen (CN); Fengde LIN, Xiamen (CN); Bin CAO, Xiamen (CN)

(21) Appl. No.: 17/194,197

(22) Filed: Mar. 5, 2021

(30) Foreign Application Priority Data
Mar. 5, 2020 (CN) 202010147337.0

(51) Int. Cl. E03C 1/04

(52) U.S. Cl. CPC E03C 1/0405; E03C 2001/026; E03C 2001/0415

(57) ABSTRACT

The present disclosure discloses a water outlet device comprises a body portion and a waterway switch device. The body portion comprises an inlet waterway, a middle waterway, and three dividing waterways. The waterway switch device is disposed on the body portion and comprises two switch valves and a button, one switch valve of two switch valves cooperates with the inlet waterway, the middle waterway, and one waterway of the three dividing waterways, and the other second switch valve of two switch valves cooperates with the middle waterway and another two waterways of the three dividing waterways. The button is configured to swing relative to the body portion, the button swings to be in one of three gear positions, and the button is operatively connected to the two switch valves to control the two switch valves.

### RELATED APPLICATIONS

This application claims priority to Chinese patent application number 202010147337.0, filed Mar. 5, 2020. Chinese patent application number 202010147337.0 is incorporated herein by reference.

### FIELD OF THE DISCLOSURE

The present disclosure relates to sanitary wares, and in particular relates to a water outlet device.

### BACKGROUND OF THE DISCLOSURE

Existing water outlet devices in the sanitary field, such as U.S. Pat. No. 7,854,401B2, provide a faucet wand, which comprises a waterway through which water can flow. The waterway comprises a body having a first cavity and a second cavity disposed therein. The first cavity and the second cavity extend in a longitudinal direction of the body. The waterway also comprises an inlet passage upstream of the first cavity and a head area located downstream of the first cavity and the second cavity and at one longitudinal end of the body. The first cavity is located upstream of the second cavity, and the body is integrally formed from a single piece of material. The waterway also comprises a plate controllably attached to the body in a fluid-sealed manner. The plate is attached to the body to surround at least one of the first cavity and the second cavity and to form a guiding pipe in the waterway. The waterway also comprises a spray surface located downstream of the first cavity and second cavity. The spray surface is controllably connected to the head area of the body. When the spray surface is connected to the head area, the spray surface is disposed along a longitudinal plane different from a center longitudinal plane of the head area. The waterway also comprises a housing. The housing comprises a part of the body with the first cavity and the second cavity. A part of the plate and the spray surface are in the housing. When the plate is connected to the body in a fluid-sealed manner, water can flow through the guiding pipe along a path substantially parallel to a plane of the plate. The waterway also comprises a valve disposed between the first cavity and the second cavity, and the valve controls fluid communication between the first cavity and the second cavity. The valve is driven by a button, and the valve can only switch between the first cavity and the second cavity. The valve cannot achieve three-way switching. There is a need for further improvement.

### BRIEF SUMMARY OF THE DISCLOSURE

The present disclosure provides a water outlet device to solve the deficiencies of the water outlet device of the existing sanitary wares of the background.

In order to solve the technical problems, a technical solution of the present disclosure is as follows.

A water outlet device comprises a body portion and a waterway switch device. The body portion comprises an inlet waterway, a middle waterway, and three dividing waterways. The waterway switch device is disposed on the body portion and comprises two switch valves and a button, one switch valve of two switch valves cooperates with the inlet waterway, the middle waterway, and one waterway of the three dividing waterways, and the other second switch valve of two switch valves cooperates with the middle waterway and another two waterways of the three dividing waterways. The button is configured to swing relative to the body portion, the button swings to be in one of three gear positions, and the button is operatively connected to the two switch valves to control the two switch valves.

In an embodiment, three gear positions respectively correspond to the three dividing waterways alternately in communication with the inlet waterway.

In an embodiment, the two switch valves comprise movable rods configured to slide to control switching, the movable rods are concave to define neck portions, the button is disposed with a middle portion swingably connected to the body portion and two connecting portions respectively disposed on two sides of the middle portion, end surfaces of the connecting portions protrude to define pulling portions, a rear surface of the button is disposed with pushing portions, the pulling portions of the connecting portions are respectively connected to the neck portions of the movable rods, and the button swings to pull the movable rods to slide by the pulling portions and to push the movable rods to slide by the pushing portions.

In an embodiment, ends of the movable rods are disposed with head portions, and the head portions are connected between the pulling portions and the pushing portions of the connecting portions.

In an embodiment, one switch valve of the two switch valves comprises a second movable rod, the second movable rod protrudes to define a shaft shoulder, the second movable rod is secured with a protrusion disposed in front of the shaft shoulder, a second sealing portion is slidably connected to the second movable rod, the second sealing portion is disposed between the protrusion and the shaft shoulder, a second elastic body is disposed between the protrusion and the second sealing portion to enable the second sealing portion to abut the shaft shoulder, a third elastic body is disposed between the shaft shoulder and the body portion to generate a backward elastic force, and the second movable rod slides to drive the second sealing portion to slide to control waterway switching.

In an embodiment, the two switch valves comprise a first switch valve and a second switch valve, the first switch valve comprises a first movable rod, the second switch valve comprises the second movable rod, the connecting portions of the button are respectively first connecting portions and second connecting portions, a first sealing portion is assembled to the first movable rod, a first elastic body is disposed between the first movable rod and the body portion to generate a forward elastic force, and the first movable rod slides to drive the first sealing portion to slide to control the waterway switching.

In an embodiment, the first switch valve cooperates with the inlet waterway, the middle waterway, and a first dividing waterway of the three dividing waterways, and the second switch valve cooperates with the middle waterway, a second dividing waterway of the three dividing waterways, and a third dividing waterway of the three dividing waterways.

In an embodiment, the two switch valves comprise a first switch valve and a second switch valve, the first switch valve comprises a first movable rod, the second switch valve comprises the second movable rod, the connecting portions of the button are respectively first connecting portions and second connecting portions, the neck portion of the first movable rod defines a first neck portion, the first movable rod comprises a first head portion, a length of the first neck portion is greater than a width between the pulling portions of the first connecting portions, a length of the first head portion is smaller than a distance between the pulling portions and the pushing portion of the first connecting portions, the neck portion of the second movable rod defines a second neck portion, the second movable rod comprises a second head portion, the second head portion cooperates with a distance between the pulling portions and the pushing portion of the second connecting portions, and the second head portion cooperates with and is connected to the pulling portions and the pushing portion of the second connecting portions.

In an embodiment, the body portion comprises a body, a first water dividing body, and a second water dividing body, the first water dividing body and the second water dividing body are secured in the body, the first switch valve is assembled to the first water dividing body, and the second switch valve is assembled to the second water dividing body.

In an embodiment, the water outlet device comprises a water outlet. The water outlet comprises three water outlet portions, the water outlet is secured to the body and cooperates with the second water dividing body, and the three water outlet portions are respectively in communication with the three dividing waterways.

In an embodiment, the water outlet device comprises a water outlet. The water outlet comprises a first water outlet portion, a second water outlet portion, and a third water outlet portion, the three dividing waterways respectively define a first dividing waterway, a second dividing waterway, and a third dividing waterway, the first dividing waterway, the second dividing waterway, and the third dividing waterway are respectively in communication with the first water outlet portion, the second water outlet portion, and the third water outlet portion, the one switch valve cooperates with the inlet waterway, the middle waterway, and the second dividing waterway, and the other switch valve cooperates with the middle waterway, the first dividing waterway, and the third dividing waterway.

In an embodiment, the first water outlet portion comprises one or more first water outlet nozzles, the second water outlet portion comprises one or more second water outlet nozzles, the first water outlet portion and the second water outlet portion define annular structures, the second water outlet portion is separated from the first water outlet portion up and down, the one or more second water outlet nozzles correspond to the one or more first water outlet nozzles to enable fluid ejected from the one or more second water outlet nozzles to flow through the one or more first water outlet nozzles, and the third water outlet portion is disposed in the annular structures of the first water outlet portion and the second water outlet portion.

In an embodiment, ends of the one or more second water outlet nozzles are separated from an inner end surface defined by inner ports of the one or more second water outlet nozzles to define a gap up and down.

In an embodiment, the annular structures of the first water outlet portion and the second water outlet portion are both circular annular structures, the one or more first water outlet nozzles comprises a plurality of first water outlet nozzles, the one or more second water outlet nozzles comprises a plurality of second water outlet nozzles, the plurality of first water outlet nozzles and the plurality of second water outlet nozzles are annularly arranged relative to an axis of the circular annular structures, and the plurality of first water outlet nozzles are aligned with the plurality of second water outlet nozzles up and down.

In an embodiment, the first water outlet portion comprises a first water outlet cover defining an annular structure, an inner peripheral edge and an outer peripheral edge of the first water outlet cover respectively extend upward to define a first inner peripheral wall and a first outer peripheral wall, the first water outlet cover comprises the one or more first water outlet nozzles, the second water outlet portion comprises a second water outlet cover defining an annular structure, an inner peripheral edge and an outer peripheral edge of the second water outlet cover respectively extend upward to define a second inner peripheral wall and a second outer peripheral wall, the second water outlet cover comprises the one or more second water outlet nozzles, the second water outlet portion is disposed between the first inner peripheral wall and the first outer peripheral wall, and the second water outlet cover is separated from the first water outlet cover up and down.

In an embodiment, in a projection along a jet direction of the one or more second water outlet nozzles, inner walls of the one or more first water outlet nozzles surround water outlet ports of the one or more second water outlet nozzle.

In an embodiment, the one or more second water outlet nozzles comprise conical sections with large upper portions and small lower portions, ends of the one or more first water outlet nozzles are circular, and minimum inner diameters of the conical sections are smaller than inner diameters of the ends of the one or more first water outlet nozzles.

In an embodiment, the water outlet device is a kitchen faucet.

Compared with the existing techniques, the technical solution has the following advantages.

Two switch valves are driven by a button (i.e., a swinging button) to realize switching, thereby achieving three-way switching. The water outlet device has a simple appearance and convenient operation.

The water outlet device comprises three dividing waterways and three water outlet portions. The first water outlet portion and the second water outlet portion are both in annular structures, and the second water outlet portion is separated from the first water outlet portion up and down. The third water outlet portion is disposed in the annular structures of the first water outlet portion and the second water outlet portion. The second water outlet nozzle corresponds to the first water outlet nozzle so that the fluid ejected from the second water outlet nozzle can pass through the first water outlet nozzle. When the features of the annular structure and the two water outlet portions being arranged up and down and cooperating with the two dividing waterways to form two kinds of water sprays are combined, the water outlet device can form three kinds of water sprays at the two water outlet areas (the first water outlet portion defines a first outlet area, the third outlet portion defines a second outlet area, and the first water outlet portion covers the second water outlet portion). The layout is reasonable and the structure is compact. This effect is especially effective when used in kitchen faucets.

The end of the second water outlet nozzle is separated from the inner end surface defined by the inner port of the first water outlet nozzle to define a gap up and down, which can prevent the second water outlet nozzle from interfering with the first water outlet nozzle and ensures that the shape of the first water outlet nozzle is not affected. Increasing the distance between the first water outlet nozzle and the second water outlet nozzle can improve a uniformity of first water outlet nozzles of the first water outlet portion.

The second water outlet portion is disposed between the first inner peripheral wall and the first outer peripheral wall, and the second water outlet cover is separated from the first water outlet cover up and down, which is convenient for assembly and compact in structure.

### BRIEF DESCRIPTION OF THE DRAWINGS

The present disclosure will be further described below in combination with the accompanying drawings and embodiments.

FIG. 1 illustrates a perspective view of a kitchen faucet of an embodiment.

FIG. 2 illustrates an exploded perspective view of the kitchen faucet of the embodiment.

FIG. 3 illustrates a first cross-sectional view of the kitchen faucet of the embodiment when water flows out of a third water outlet portion.

FIG. 4 illustrates a second cross-sectional view of the kitchen faucet of the embodiment when water flows out of a first water outlet portion.

FIG. 5 illustrates a third cross-sectional view of the kitchen faucet of the embodiment when water flows out of a second water outlet portion.

FIG. 6 illustrates a fourth cross-sectional view of the kitchen faucet of the embodiment when water flows out of the second water outlet portion.

FIG. 7 illustrates a fifth cross-sectional view of the kitchen faucet of the embodiment when water flows out of the second water outlet portion.

FIG. 8 illustrates a perspective view of a first water dividing body of the embodiment.

FIG. 9 illustrates a cross-sectional view of the first water dividing body of the embodiment.

FIG. 10 illustrates a first perspective view of a second water dividing body of the embodiment.

FIG. 11 illustrates a second perspective view of the second water dividing body of the embodiment.

FIG. 12 illustrates a first cross-sectional view of the second water dividing body of the embodiment.

FIG. 13 illustrates a second cross-sectional view of the second water dividing body of the embodiment.

FIG. 14 illustrates a perspective view of a button of the embodiment.

### DETAILED DESCRIPTION OF THE EMBODIMENTS

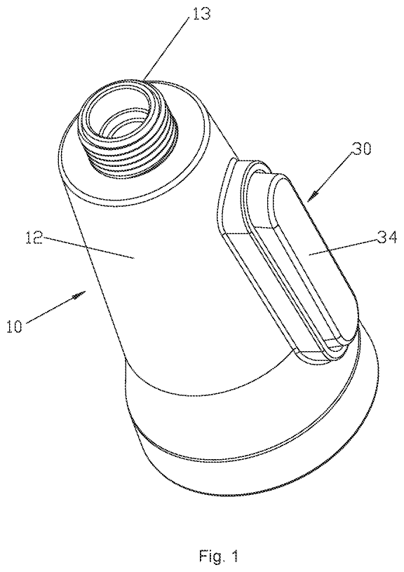

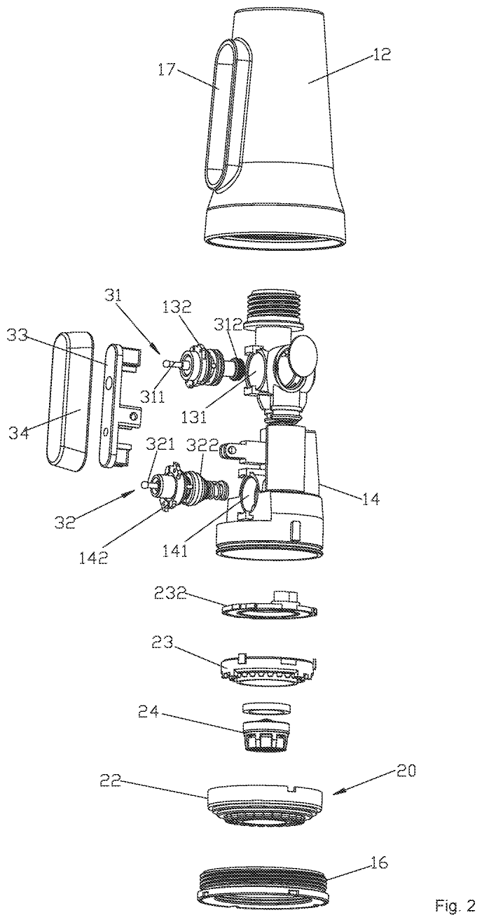

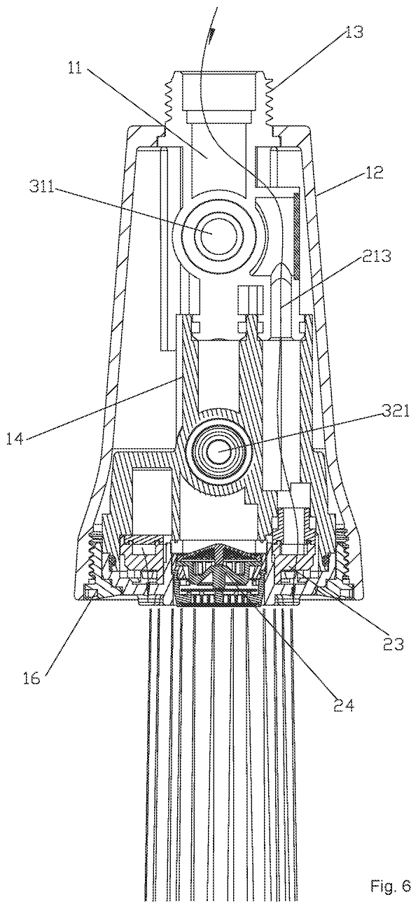

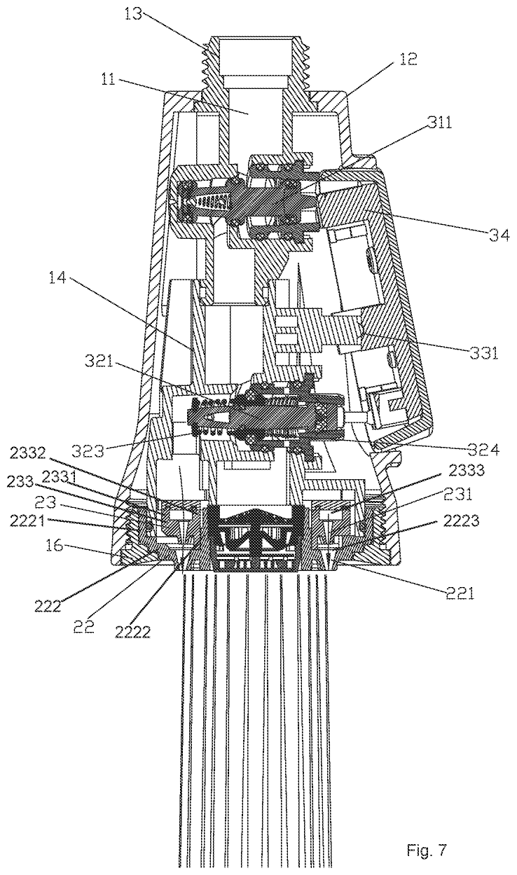

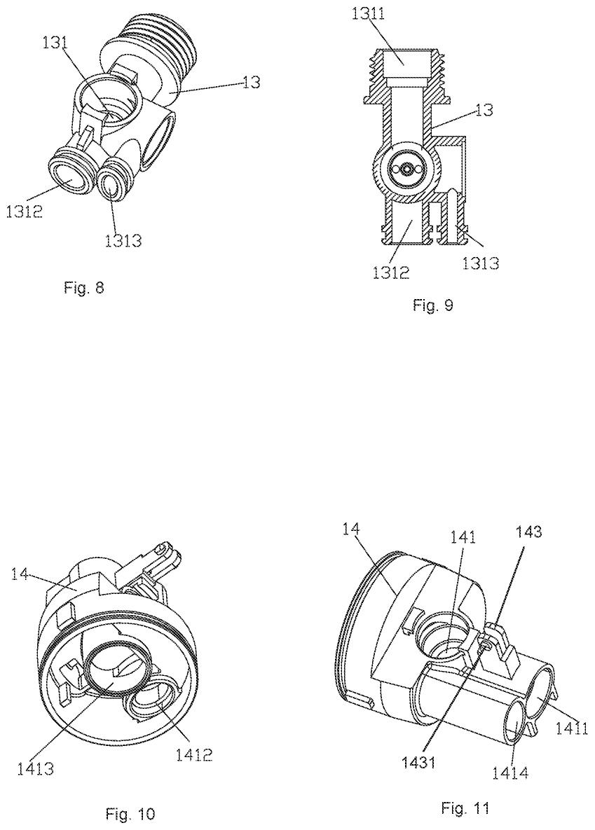

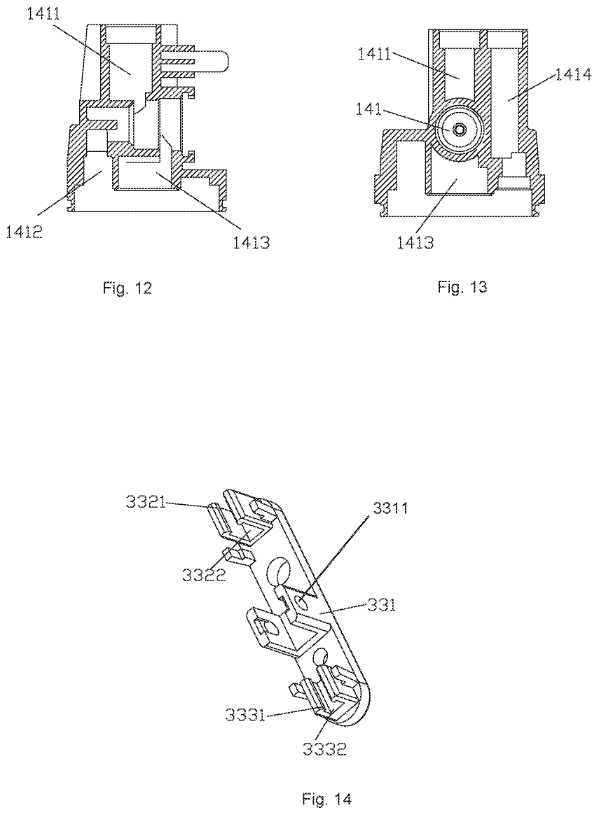

Referring to FIGS. 1-14, a kitchen faucet comprises a body portion 10, a waterway switch device 30, and a water outlet 20. The body portion 10 comprises an inlet waterway 11, a middle waterway 15, and three dividing waterways 211, 212, and 213. The water outlet 20 comprises a first water outlet portion 22 comprising a first water outlet nozzle 221, a second water outlet portion 23 comprising a second water outlet nozzle 231, and a third water outlet portion 24. The waterway switch device 30 is connected to the inlet waterway 11 and the three dividing waterways 211, 212, and 213 to switch the three dividing waterways 211, 212, and 213 to be alternately in communication with the inlet waterway 11.

The body portion 10 comprises a body 12, a first water dividing body 13, and a second water dividing body 14. The body 12 defines a shell structure. The first water dividing body 13 and the second water dividing body 14 are secured in the body 12, and the water outlet 20 is secured to the body 12 and cooperates with the second water dividing body 14. The waterway switch device 30 comprises a first switch valve 31, a second switch valve 32, and a button 33. The three dividing waterways 211, 212, and 213 are respectively a first dividing waterway 211, a second dividing waterway 212, and a third dividing waterway 213. The first switch valve 31 is assembled to the first water dividing body 13 and is connected to the second dividing waterway 212, the middle waterway 15, and the inlet waterway 11 to switch the second dividing waterway 212 and the middle waterway 15 to be alternately in communication with the inlet waterway 11. The second switch valve 32 is connected to the middle waterway 15, the first dividing waterway 211, and the third dividing waterway 213 to switch the first dividing waterway 211 and the third dividing waterway 213 to be alternately in communication with the middle waterway 15. The button 33 is swingably connected to the body portion 10 and two ends of the button 33 are respectively and operatively connected to the first switch valve 31 and the second switch valve 32. The button 33 can be positioned in three gear positions relative to the body portion 10 to achieve waterway switching by pressing the button 33.

In this embodiment: the first water dividing body 13 is concave to define a first water dividing cavity 131, a first pipeline 1311 configured to enable the first water dividing cavity 131 to be in communication with an upper port of the first water dividing body 13, and two second pipelines 1312 and 1313 in communication with the first water dividing cavity 131. The inlet waterway 11 comprises the first pipeline 1311, the middle waterway 15 comprises a first second pipeline 1312 of two second pipelines 1312 and 1313, and the second dividing waterway 212 comprises a second second pipeline 1313 of two second pipelines 1312 and 1313. A part 132 is secured to a concave opening of the first water dividing cavity 131. The first switch valve 31 is assembled in the first water dividing cavity 131 to achieve waterway switching, and the first switch valve 31 comprises a first movable rod 311 slidably connected to the part 132, a first sealing portion 312 secured to (i.e., assembled to) the first movable rod 311, and a first spring 313. The first sealing portion 312 comprises a first sealing ring secured to the first movable rod 311, and the first spring 313 abuts and is disposed between a cavity bottom of the first water dividing cavity 131 and a rear portion of the first movable rod 311 to enable the first movable rod 311 to be subjected to a forward elastic force. The first movable rod 311 slides between a first switch position and a second switch position to drive the first sealing portion 312 to slide to achieve waterway switching. A front portion of the first movable rod 311 extends out of the part 132, and an outer rotating wall of the front portion of the first movable rod 311 is concave to define an annular groove. The annular groove defines a first neck portion 3111. A portion of the first movable rod 311 disposed in front of the annular groove defines a first head portion 3112, and an outer diameter of the first head portion 3112 is larger than an outer diameter of the first neck portion 3111.

In this embodiment: the second water dividing body 14 is concave to define a second water dividing cavity 141, a fourth pipeline 1411 configured to enable the second water dividing cavity 141 to be in communication with an upper port of the second water dividing body 14, and two fifth pipelines 1412 and 1413 in communication with the second water dividing cavity 141. The second water dividing body 14 is further disposed with a third pipeline 1414 configured to penetrate an upper end and a lower end of the second water dividing body 14. The third pipeline 1414 and the fourth pipeline 1411 of the second water dividing body 14 respectively encompass (or are encompassed in) and are respectively in communication with the two second pipelines 1312 and 1313 of the first water dividing body 13. The second dividing waterway 212 comprises the third pipeline 1414, and the second second pipeline 1313 encompasses (or is encompassed in) and is in communication with the third pipeline 1414. The middle waterway 15 comprises the fourth pipeline 1411, and the first second pipeline 1312 encompasses (or is encompassed in) and is in communication with the fourth pipeline 1411. The first dividing waterway 211 comprises a first fifth pipeline 1412 of the two fifth pipelines 1412 and 1413, and the third dividing waterway 213 comprises a second fifth pipeline 1413 of the two fifth pipelines 1412 and 1413. The second water dividing cavity 141 is secured with a valve body 142. The second switch valve 32 is assembled to the second water dividing body 14. The second switch valve 32 comprises a second movable rod 321 slidably connected to the valve body 142, a second sealing portion 322, a second spring 323, and a third spring 324. The second movable rod 321 protrudes to define a shaft shoulder 3213 and a protrusion 3214 disposed in front of the shaft shoulder 3213. The second sealing portion 322 comprises a sliding base 3221 and a second sealing ring 3222 fixedly encompassing an outer side of the sliding base 3221, and the second movable rod 321 is slidably connected to the sliding base 3221 of the second sealing portion 322. The second sealing portion 322 is disposed between the shaft shoulder 3213 and the protrusion 3214, and the second spring 323 is disposed between the protrusion 3214 and the second sealing portion 322 to enable the second sealing portion 322 to abut the shaft shoulder 3213. The second sealing portion 322 and the second movable rod 321 define an entity due to the second spring 323, and the entity is convenient to assemble. The third spring 324 drives the second switch valve 32 to move backward to seal a first water switching port 1415 after water is turned off. The third spring 324 is disposed between the shaft shoulder 3213 and the valve body 142, so that the second movable rod 321 is subjected to a backward elastic force of the third spring 324. The second movable rod 321 is configured to slide between a third switch position and other positions relative to the second water dividing body 14, and a fourth switch position is disposed between the third switch position and the other positions. A function of the second spring 323 and the third spring 324 is as follows: when the second movable rod 321 slides between the third switch position and the fourth switch position, the second movable rod 321 drives the second sealing portion 322 to slide synchronously to control the waterway switching. When the second movable rod 321 slides between the fourth switch position and the other positions, the second sealing portion 322 does not move due to a restriction of the valve body 142. At this time, the second movable rod 321 slides between the fourth switch position and the other positions and is idle (i.e., not engaged with the second sealing portion 322). In some embodiments, the second water dividing cavity 141 comprises the first water switching port 1415 in communication with the first fifth pipeline 1412, and the valve body 142 comprises a second water switching port 1416 in communication with the second fifth pipeline 1413. The first water switching port 1415 faces and is separated from the second water switching port 1416, and the second sealing portion 322 is disposed between the first water switching port 1415 and the second water switching port 1416. When the second sealing portion 322 hermetically abuts the first water switching port 1415, the second water switching port 1416 is in communication with the second fifth pipeline 1413. When the second sealing portion 322 hermetically abuts the second water switching port 1416, the first water switching port 1415 is in communication with the first fifth pipeline 1412. A front portion of the second movable rod 321 extends out of the valve body 142, and an outer rotating wall of the front portion of the second movable rod 321 is concave to define an annular groove. The annular groove defines a second neck portion 3211. A portion of the second movable rod 321 disposed in front of the annular groove defines a second head portion 3212, and an outer diameter of the second head portion 3212 is larger than an outer diameter of the second neck portion 3211.

In this embodiment, a middle of a rear surface of the button 33 protrudes to define a middle portion 331, and the middle portion 331 is rotatably (i.e., swingably) connected to the second water dividing body 14 to enable the button 33 to swing relative to the second water dividing body 14, which is similar to a seesaw. The middle portion 331 is concave to define a first pivot hole 3311. The second water dividing body 14 protrudes to define a second protrusion 143, and the second protrusion 143 comprises a second pivot hole 1431. A pivot shaft is further provided to be connected to the first pivot hole 3311 and the second pivot hole 1431 to enable the button 33 to be swingably connected to the second water dividing body 14. Each of two ends of the rear surface of the button 33 protrudes to define two connecting portions 332, so that end surfaces of the two connecting portions 332 extend toward each other to define first pulling portions 3321. First pushing portions 3322 and 3332 are defined between the two connecting portions 332 of the two ends of the rear surface of the button 33. Each end of the two ends of the button 33 is disposed with the two connecting portions, so that an upper side and a lower side of the middle portion 331 are respectively disposed with the two connecting portions. The two connecting portions disposed on the upper side of the middle portion 331 define first connecting portions 332. The first connecting portions 332 are disposed with first pulling portions 3321, and the pushing portion of the first connecting portions 332 defines a first pushing portion 3322. The two connecting portions disposed on the lower side of the middle portion 331 define second connecting portions 333. The second connecting portions 333 are disposed with second pulling portions 3331, and the pushing portion of the second connecting portions 333 defines a second pushing portion 3332. The body 12 comprises a through hole 17 penetrating an inner side and an outer side, and the button 33 is disposed in and extends out of the through hole 17 for pressing by a user. An outer side of the button 33 is encompassed in a button sleeve 34 to improve a pressing comfort of the user.

In this embodiment: the first head portion 3112 of the first movable rod 311 is disposed between the first connecting portions 332 and is disposed between the first pulling portions 3321 and the first pushing portion 3322. The first pulling portions (i.e., two first pulling portions) 3321 are connected to the first neck portion 3111 to enable the button 33 to be operatively connected to the first movable rod 311, so that the button 33 swings to drive the first movable rod 311 to slide. A length of the first neck portion 3111 is larger than a distance between the first pulling portions 3321 and the first pushing portion 3322. Therefore, each swing track of the button 33 is divided into two parts, in a first part of two parts, the button 33 swings to drive the first movable rod 311 to slide, and in a second part of two parts, the button 33 swings and is idle (i.e., not engaged with the first movable rod 311). The second head portion 3212 of the second movable rod 321 is disposed between the two second connecting portions 333 and is disposed between the second pulling portions 3331 and the second pushing portion 3332. The second pulling portions (i.e., two second pulling portions) 3331 are connected to the second neck portion 3211 to enable the button 33 to be operatively connected to and the second movable rod 321, so that the button 33 swings to drive the second movable rod 321 to slide. The second head portion 3212 cooperates with a distance between the second pulling portions 3331 and the second pushing portion 3332 of the second connecting portion 333. The second head portion 3212 cooperates with and is connected between the second pulling portions 3331 and the second pushing portion 3332 of the second connecting portion 333, so that the button 33 swings to drive the second movable rod 321 to slide. In some embodiments: when a lower end of the button 33 drives the second movable rod 321 to slide between the third switch position and the fourth switch position, an upper end of the button 33 and the first movable rod 311 are idle (i.e., not engaged with the first movable rod 311).

The first water outlet portion 22 and the second water outlet portion 23 both define annular structures (i.e., circular annular structures), and the second water outlet portion 23 is separated from the first water outlet portion 22 up and down. The third water outlet portion 24 is disposed in the circular annular structures of the first water outlet portion 22 and the second water outlet portion 23. The three dividing waterways 211, 212, and 213 are respectively in communication with the first water outlet nozzle 221, the second water outlet nozzle 231, and the third water outlet portion 24. A plurality of first water outlet nozzles 221 of the first water outlet portion 22 are annularly arranged relative to an axis of the circular annular structures, and a plurality of second water outlet nozzles 231 of the second water outlet portion 23 are annularly arranged relative to the axis of the circular annular structures. Further, the plurality of first water outlet nozzles 221 are aligned with the plurality of second water outlet nozzles 231 up and down, and the plurality of second water outlet nozzles 231 correspond to the plurality of first water outlet nozzles 221 to enable fluid ejected from the plurality of second water outlet nozzles 231 to flow through the plurality of first water outlet nozzles 221. In some embodiments, in a projection along a jet direction of the plurality of second water outlet nozzles 231, inner walls of the plurality of first water outlet nozzles 221 surround and are separated from water outlet ports of the plurality of second water outlet nozzles 231 to define gaps, so that the fluid ejected from the plurality of second water outlet nozzles 231 can flow through the plurality of first water outlet nozzles 221.

The first water outlet portion 22 comprises a first water outlet cover 222 defining an annular structure. An inner peripheral edge and an outer peripheral edge of the first water outlet cover 222 respectively extend upward to form a first inner peripheral wall 2222 and a first outer peripheral wall 2221. The first water outlet cover 222 comprises the first water outlet nozzle 221 (i.e., the plurality of first water outlet nozzles 221). The second water outlet portion 23 comprises a second water outlet cover 233 defining an annular structure. An inner peripheral edge and an outer peripheral edge of the second water outlet cover 233 respectively extend upward to define a second inner peripheral wall 2332 and a second outer peripheral wall 2331, and the second water outlet cover 233 comprises the second water outlet nozzle 231 (i.e., the plurality of second water outlet nozzles 231). The second water outlet portion 23 is disposed between the first inner peripheral wall 2222 and the first outer peripheral wall 2221, and the second water outlet cover 233 is separated from the first water outlet cover 222 up and down. Further, an end of the second water outlet nozzle 231 is separated from the first water outlet cover 222 to define a gap up and down, so that the end of the second water outlet nozzle 231 is separated from an inner end surface defined by an inner port of the first water outlet nozzle 221 to define the gap up and down to avoid water discharging from the first water outlet nozzle 221 from interference with the second water outlet nozzle 231. In some embodiments, the first outer peripheral wall 2221 is secured in a lower port of the body 12. An annular plate 232 is secured between the second inner peripheral wall 2332 and the second outer peripheral wall 2331 of the second water outlet portion 23, and a second water outlet cavity 2333 is defined between the second water outlet portion 23 and the annular plate 232. The annular plate 232 is disposed with a joint configured to be in communication with the second water outlet cavity 2333. A first water outlet cavity 2223 is defined between the first water outlet portion 22 and the second water outlet cover 233. The first dividing waterway 211 comprises the first water outlet cavity 2223, and the first fifth pipeline 1412 is in communication with the first water outlet cavity 2223. The second dividing waterway 212 comprises the second water outlet cavity 2333, and the third pipeline 1414 is in communication with the joint and the second water outlet cavity 2333. The first outer peripheral wall 2221 is connected to the lower port of the body 12 through a threaded sleeve 16.

The second water outlet nozzle 231 defines a second conical section with a large upper portion and a small lower portion. The first water outlet nozzle 221 defines a first conical section. A minimum inner diameter of the second conical section is smaller than a minimum inner diameter of the first conical section. Further, an inclination angle of the second conical section is greater than an inclination angle of the first conical section, so as to increase water speed and increase hydraulic power.

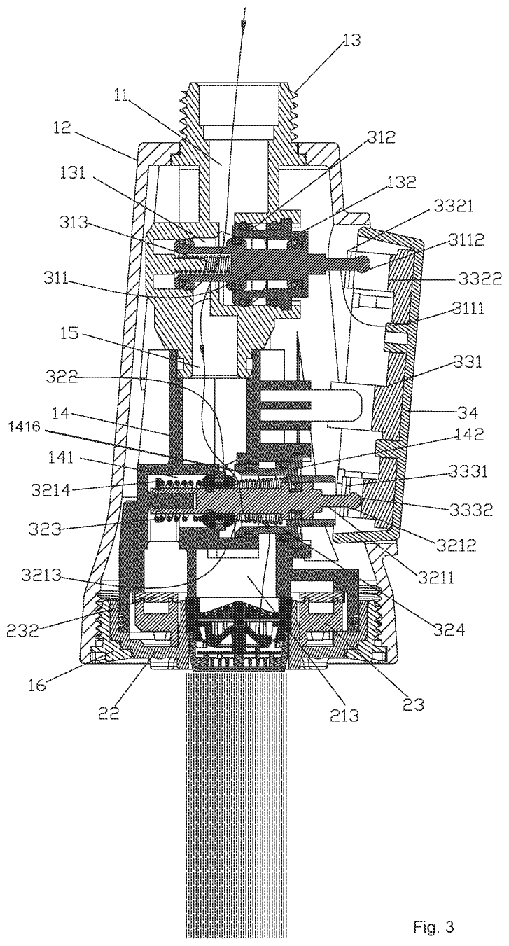

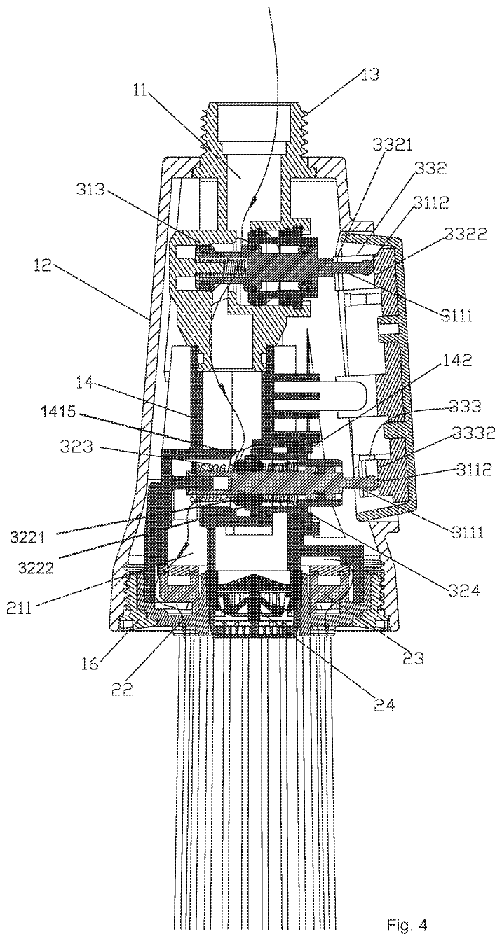

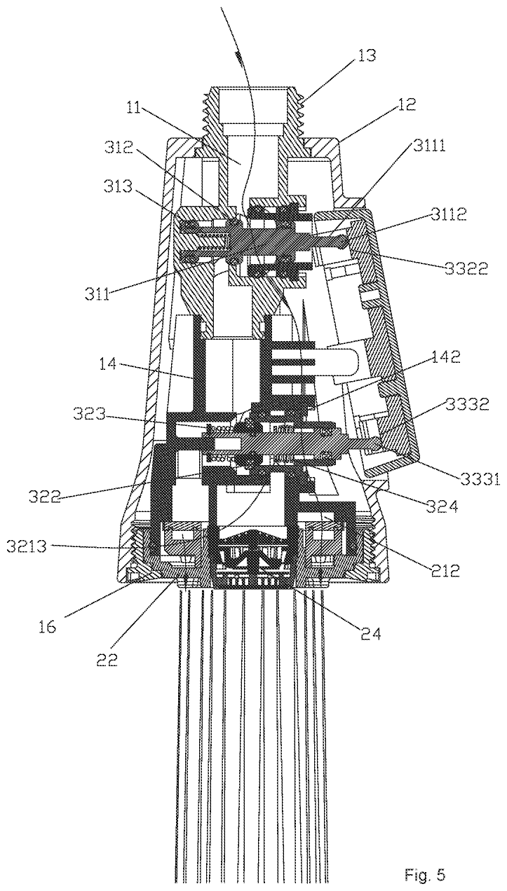

The third water outlet portion 24 is, for example, an aerator to discharge aerated water. The first water outlet portion 22, for example, discharges ordinary shower water. The second water outlet portion 23, for example, discharges powerful shower water. The aerated water is used to create water that does not splash. The ordinary shower water is used for washing vegetables, and the powerful shower water is used for washing dishes, etc. When the kitchen faucet discharges aerated water, water flows out of the aerator. When the kitchen faucet discharges shower water, water flows out of the first water outlet portion 22. When the kitchen faucet discharges strong water, water firstly flows through the second water outlet portion 23 and is then ejected out of the first water outlet nozzle 221 of the first water outlet portion 22. The kitchen faucet is switched by the button 33 defining a boat shape. Referring to FIG. 3, a view of a working state of the aerated water defines a view of an initial state of the kitchen faucet. At this time, the first switch valve 31 is in the first switch position, and the second switch valve 32 is also in the third switch position, the aerated water flows out of the kitchen faucet. When the upper end of the button 33 is pressed, the button 33 swings and is idle (i.e., not engaged with the first movable rod 311), the first switch valve 31 is maintained in the initial state and unchanged, and the second switch valve 32 is switched to the fourth switch position. Referring to FIG. 4, the shower water flows out of the kitchen faucet. The upper end of the button 33 is continuously pressed, the button 33 drives the first movable rod 311 to slide, the first switch valve 31 is switched to the second position, and the second switch valve 32 slides from the fourth switch position to the other positions. Referring to FIGS. 5, 6, and 7, powerful shower water flows out of the kitchen faucet. When the water is turned off and turned on again, water spray of the kitchen faucet will return to an aerated water mode.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A water outlet device, comprising:
a body portion, and
a waterway switch device, wherein:
the body portion comprises an inlet waterway, a middle waterway, and three dividing waterways,
the waterway switch device is disposed on the body portion and comprises two switch valves and a button,
one switch valve of two switch valves cooperates with the inlet waterway, the middle waterway, and one waterway of the three dividing waterways,
the other second switch valve of two switch valves cooperates with the middle waterway and another two waterways of the three dividing waterways,
the button is configured to swing relative to the body portion,
the button swings to be in one of three gear positions, and
the button is operatively connected to the two switch valves to control the two switch valves.

2. The water outlet device according to claim 1, wherein the three gear positions respectively correspond to the three dividing waterways alternately in communication with the inlet waterway.

3. The water outlet device according to claim 1, wherein:
the two switch valves comprise movable rods configured to slide to control switching,
the movable rods are concave to define neck portions,
the button is disposed with a middle portion swingably connected to the body portion and two connecting portions respectively disposed on two sides of the middle portion,
end surfaces of the connecting portions protrude to define pulling portions,
a rear surface of the button is disposed with pushing portions,
the pulling portions of the connecting portions are respectively connected to the neck portions of the movable rods, and
the button swings to pull the movable rods to slide by the pulling portions and to push the movable rods to slide by the pushing portions.

4. The water outlet device according to claim 3, wherein:
ends of the movable rods are disposed with head portions, and
the head portions are connected between the pulling portions and the pushing portions of the connecting portions.

5. The water outlet device according to claim 3, wherein:
one switch valve of the two switch valves comprises a second movable rod,
the second movable rod protrudes to define a shaft shoulder,
the second movable rod is secured with a protrusion disposed in front of the shaft shoulder,
a second sealing portion is slidably connected to the second movable rod,
the second sealing portion is disposed between the protrusion and the shaft shoulder,
a second elastic body is disposed between the protrusion and the second sealing portion to enable the second sealing portion to abut the shaft shoulder,
a third elastic body is disposed between the shaft shoulder and the body portion to generate a backward elastic force, and
the second movable rod slides to drive the second sealing portion to slide to control waterway switching.

6. The water outlet device of claim 5, wherein:
the two switch valves comprise a first switch valve and a second switch valve,
the first switch valve comprises a first movable rod,
the second switch valve comprises the second movable rod,
the connecting portions of the button are respectively first connecting portions and second connecting portions,
a first sealing portion is assembled to the first movable rod,
a first elastic body is disposed between the first movable rod and the body portion to generate a forward elastic force, and
the first movable rod slides to drive the first sealing portion to slide to control the waterway switching.

7. The water outlet device according to claim 6, wherein:
the first switch valve cooperates with the inlet waterway, the middle waterway, and a first dividing waterway of the three dividing waterways, and
the second switch valve cooperates with the middle waterway, a second dividing waterway of the three dividing waterways, and a third dividing waterway of the three dividing waterways.

8. The water outlet device of claim 5, wherein:
the two switch valves comprise a first switch valve and a second switch valve,
the first switch valve comprises a first movable rod,
the second switch valve comprises the second movable rod,
the connecting portions of the button are respectively first connecting portions and second connecting portions,
the neck portion of the first movable rod defines a first neck portion,
the first movable rod comprises a first head portion,
a length of the first neck portion is greater than a distance between the pulling portions and the pushing portion of the first connecting portions,
the neck portion of the second movable rod defines a second neck portion,
the second movable rod comprises a second head portion,
the second head portion cooperates with a distance between the pulling portions and the pushing portion of the second connecting portions, and
the second head portion cooperates with and is connected to the pulling portions and the pushing portion of the second connecting portions.

9. The water outlet device according to claim 6, wherein:
the body portion comprises a body, a first water dividing body, and a second water dividing body,
the first water dividing body and the second water dividing body are secured in the body,
the first switch valve is assembled to the first water dividing body, and
the second switch valve is assembled to the second water dividing body.

10. The water outlet device according to claim 9, comprising:
a water outlet, wherein:
the water outlet comprises three water outlet portions,
the water outlet is secured to the body and cooperates with the second water dividing body, and
the three water outlet portions are respectively in communication with the three dividing waterways.

11. The water outlet device according to claim 1, comprising:
a water outlet, wherein:
the water outlet comprises a first water outlet portion, a second water outlet portion, and a third water outlet portion,
the three dividing waterways respectively define a first dividing waterway, a second dividing waterway, and a third dividing waterway,
the first dividing waterway, the second dividing waterway, and the third dividing waterway are respectively in communication with the first water outlet portion, the second water outlet portion, and the third water outlet portion,
the one switch valve cooperates with the inlet waterway, the middle waterway, and the second dividing waterway, and
the other switch valve cooperates with the middle waterway, the first dividing waterway, and the third dividing waterway.

12. The water outlet device of claim 11, wherein:
the first water outlet portion comprises one or more first water outlet nozzles,
the second water outlet portion comprises one or more second water outlet nozzles,
the first water outlet portion and the second water outlet portion define annular structures,
the second water outlet portion is separated from the first water outlet portion up and down,
the one or more second water outlet nozzles correspond to the one or more first water outlet nozzles to enable fluid ejected from the one or more second water outlet nozzles to flow through the one or more first water outlet nozzles, and
the third water outlet portion is disposed in the annular structures of the first water outlet portion and the second water outlet portion.

13. The water outlet device according to claim 12, wherein ends of the one or more second water outlet nozzles are separated from an inner end surface defined by inner ports of the one or more second water outlet nozzles to define a gap up and down.

14. The water outlet device according to claim 12, wherein:
the annular structures of the first water outlet portion and the second water outlet portion are both circular annular structures,
the one or more first water outlet nozzles comprises a plurality of first water outlet nozzles,
the one or more second water outlet nozzles comprises a plurality of second water outlet nozzles,
the plurality of first water outlet nozzles and the plurality of second water outlet nozzles are annularly arranged relative to an axis of the circular annular structures, and
the plurality of first water outlet nozzles are aligned with the plurality of second water outlet nozzles up and down.

15. The water outlet device according to claim 12, wherein:
the first water outlet portion comprises a first water outlet cover defining an annular structure,
an inner peripheral edge and an outer peripheral edge of the first water outlet cover respectively extend upward to define a first inner peripheral wall and a first outer peripheral wall,
the first water outlet cover comprises the one or more first water outlet nozzles,
the second water outlet portion comprises a second water outlet cover defining an annular structure,
an inner peripheral edge and an outer peripheral edge of the second water outlet cover respectively extend upward to define a second inner peripheral wall and a second outer peripheral wall,
the second water outlet cover comprises the one or more second water outlet nozzles,
the second water outlet portion is disposed between the first inner peripheral wall and the first outer peripheral wall, and
the second water outlet cover is separated from the first water outlet cover up and down.

16. The water outlet device of claim 12, wherein:
in a projection along a jet direction of the one or more second water outlet nozzles, inner walls of the one or more first water outlet nozzles surround water outlet ports of the one or more second water outlet nozzle.

17. The water outlet device according to claim 12, wherein:
the one or more second water outlet nozzles comprise conical sections with large upper portions and small lower portions,
ends of the one or more first water outlet nozzles are circular, and
minimum inner diameters of the conical sections are smaller than inner diameters of the ends of the one or more first water outlet nozzles.

18. The water outlet device according to claim 1, wherein the water outlet device is a kitchen faucet.
